(19) United States
(12) Patent Application Publication
(10) Pub. No.: US 2020/0386544 A1
(43) Pub. Date: Dec. 10, 2020

(54) MAP POINT CREATION AND VIEWING SYSTEMS AND METHODS

(71) Applicant: Lenzmark LLC, Eagle Mountain, UT (US)

(72) Inventors: John F. Blair, Eagle Mountain, UT (US); Forrest K. Blair, Highland, UT (US)

(21) Appl. No.: 16/891,041

(22) Filed: Jun. 2, 2020

Related U.S. Application Data
(60) Provisional application No. 62/858,233, filed on Jun. 6, 2019.

(51) Int. Cl. G01C 11/02; G06F 3/14

(52) U.S. Cl. CPC G01C 11/02; G06F 3/14

(57) ABSTRACT

Systems and methods for creating, viewing, and/or sharing points on a map and related information, such as distance data. In some embodiments, the system may comprise a plurality of client devices having cameras or other viewers. The system may be configured to plot a point on a map, in some cases including terrain details, and may depict various additional details, such as distances to related objects, to the user of the client device and/or other users in the system. In some embodiments, the accuracy of the various points and/or distances may be improved using error compensation methods.

### CROSS-REFERENCE TO RELATED APPLICATIONS

This application claims the benefit under 35 U.S.C. § 119(e) of U.S. Provisional Patent Application No. 62/858,233, which was filed Jun. 6, 2019 and titled “MAP POINT CREATION AND VIEWING SYSTEMS AND METHODS,” which is hereby incorporated herein by reference in its entirety.

### SUMMARY

Systems and methods are disclosed herein that relate to creation of one or more points on a map using a client device and/or companion device having an optical viewer, and one or more sensors to provide spatial information and/or terrain data. In some embodiments and implementations, the accuracy of the map points and/or distance markers provided on the map may be improved using techniques to reduce compass errors. Some embodiments may further provide users with a visual of a map point and distances, preferably including adjustments for surrounding terrain and/or elevations superimposed on an optical view. Map point data, including locations of various targets/items of interest and/or user locations, may be shared with other users in a particular group, in some cases in real time and/or with real-time communication. Some embodiments may also allow for users and/or software modules, such as AI software modules and/or pre-trained neural networks, to identify and classify objects in the optical view and, once again, share the information with other users if desired.

In a more specific example of a method for identifying and visualizing points on a map according to some implementations, the method may comprise identifying a target with a viewfinder, such as a viewfinder on a mobile smartphone, a companion device to a mobile smartphone, or a pair of binoculars or another suitable optical device, for example. The target may then be correlated with a location on a map using a GPS signal received on a mobile device operated by a user (either the user who identified the target or another user of a network of users). Preferably, the mobile device and/or the device used to identify the target comprises one or more sensors, such as gyroscopes, magnetometers, and the like. A visual representation of the target, such as an icon or another marker, may then be displayed on the map, such as on a display screen of the mobile device on an app running on the mobile device. Location data relating to the target may then be transmitted to a second user to allow the second user, which may be operating the app on a second mobile device, to identify the target on a map, such as a map on a display of the second mobile device operated by the second user.

In some implementations, the viewfinder may be part of the mobile device. Alternatively, the viewfinder may be part of a companion device communicatively coupled with the mobile device, such as binoculars, a monocular, a rangefinder, or an optical scope.

Some implementations may further comprise receiving location data generated from the second user. The location data generated from the second user may allow a location of the target to be identified on the map with greater precision.

In some implementations, the map may comprise relative distance markers between two or more targets on the map, which may in some such implementations be automatically displayed by the app to allow a user, such as a golfer, to visualize distances between relevant points on the map/display.

In an example of a method for collaboratively identifying targets on a map, the method may comprise identifying a target within a viewfinder of binoculars, a monocular, a rangefinder, and/or an optical scope operated by a user and correlating the target with a location on a map, which may be done automatically using a processor and accompanying software provided on a mobile device or on the device with the viewfinder itself. A visual representation of the target may be displayed on the map. Location data relating to the target may be transmitted to a second user to allow the second user to identify the target on a second map displayed to the second user. The location data may be transmitted to the second user directly from the first user or from, for example, a remote server comprising one or more processors.

Some implementations may further comprise receiving location data relating to a second target. The location data relating to the second target may be generated from a device operated by the second user, such as any of the devices used by the first user to identify the first target.

Some implementations may further comprise displaying one or more visual cues to assist the user in identifying a location of the second target on the map, such as horizontal, lines and/or vertical lines intersecting the second target.

Some implementations may further comprise displaying a prompt to direct the user towards the second target, such as arrows, which may be placed on at least one of the horizontal and vertical lines when such lines are displayed on the map.

In some implementations, the map may be displayed within the viewfinder and/or on a screen of a mobile device communicatively coupled with at least one of binoculars, a monocular, a rangefinder, and an optical scope operated by the user.

Some implementations may further comprise downloading one or more location-specific data modules that may include data relating to geographical features of a specific location, which may improve the accuracy of target, location, and/or distance estimates on maps of the specific location. In some such implementations, the location-specific module may be used to correlate targets identified with the viewfinder with locations on the map and may allow for doing so without access to the Internet. Thus, the location-specific module may allow for correlation of targets identified with the viewfinder without use of an Internet network connection.

In an example of a non-transitory computer-readable storage media having computer-executable instructions that, when executed by at least one processor, cause the at least one processor to perform a method according to some embodiments, the method performed by the processor may comprise the steps of correlating a target identified within a viewfinder with a location on a map using data generated from GPS signal received on a mobile device operated by a user and one or more sensors of the mobile device. A visual representation of the target may be displayed on the map. Location data relating to the target may be received from a second user and the accuracy of the visual representation of the target on the map may be improved using the location data from the second user.

In some embodiments, the processor may further estimate distances between two or more secondary targets, or between a secondary target and the target, on the map. In some such embodiments, the processor may display one or more distance markers on the map, the one or more distance markers being representative of estimated distances between two targets on the map.

In some embodiments, the processor may further display one or more visual cues to assist the user in identifying a second target identified by another user, such as arrows and/or axes/lines intersecting the second target on a displayed map.

The features, structures, steps, or characteristics disclosed herein in connection with one embodiment may be combined in any suitable manner in one or more alternative embodiments.

### BRIEF DESCRIPTION OF THE DRAWINGS

Non-limiting and non-exhaustive embodiments of the disclosure are described, including various embodiments of the disclosure with reference to the figures, in which:

FIG. 1 depicts an example of a system for creation and viewing of points on a digital map according to some embodiments;

FIG. 2A depicts a target object within a viewer of a client device from a first perspective;

FIG. 2B depicts the target object of the viewer of from a second perspective taken to provide error correction data to improve the accuracy of the positioning of the target object and/or surrounding distances on a digital map;

FIG. 3 is a schematic diagram illustrating a technique for imaging a target object from different perspectives to improve the accuracy of the positioning of the target object and/or surrounding distances on a digital map;

FIG. 4 depicts a map highlighting the location of an object of interest and the user's current location, along with a line connecting the two points, which may be used to plot the object of interest on the map via use of compass and/or other sensors on a client device;

FIG. 5 is another schematic diagram illustrating a technique for imaging a target object from different perspectives and using compass error data to improve the accuracy of the positioning of the target object and/or surrounding distances on a digital map;

FIG. 6 depicts a viewing window of a client device with a marker of a location of interest and distance markers overlaid on the display;

FIG. 7 is a perspective view of a pair of binoculars that have been modified with a display overlay and various components useful for identification of targets within a map/display visible in the binoculars;

FIGS. 8A-8C depict various display/map features that may be used to assist users in identifying targets;

FIG. 9 is a schematic diagram illustrating a method for improving the precision of remotely locating a target on a map by reducing the error introduced by sensors and/or other elements of a mobile device; and

FIG. 10 is a flow chart illustrating an example of a method for reducing error and thereby improving the precision of target placement on a display/map.

### DETAILED DESCRIPTION

A detailed description of apparatus, systems, and methods consistent with various embodiments of the present disclosure is provided below. While several embodiments are described, it should be understood that the disclosure is not limited to any of the specific embodiments disclosed, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

Methods and systems are disclosed herein relating to systems and methods for improving the ability of mapping a location and/or item of interest on a map or real-time viewer. In some embodiments, this may be done on a terrain map and/or current view having elevation changes, and may allow for providing markings to indicate relative and/or absolute distances between the user and locations of interest and/or between the locations of interest themselves. The embodiments of the disclosure may be best understood by reference to the drawings, wherein like parts may be designated by like numerals. It will be readily understood that the components of the disclosed embodiments, as generally described and illustrated in the figures herein, could be arranged and designed in a wide variety of different configurations. Thus, the following detailed description of the embodiments of the apparatus and methods of the disclosure is not intended to limit the scope of the disclosure, as claimed, but is merely representative of possible embodiments of the disclosure. In addition, the steps of a method do not necessarily need to be executed in any specific order, or even sequentially, nor need the steps be executed only once, unless otherwise specified. Additional details regarding certain preferred embodiments and implementations will now be described in greater detail with reference to the accompanying drawings.

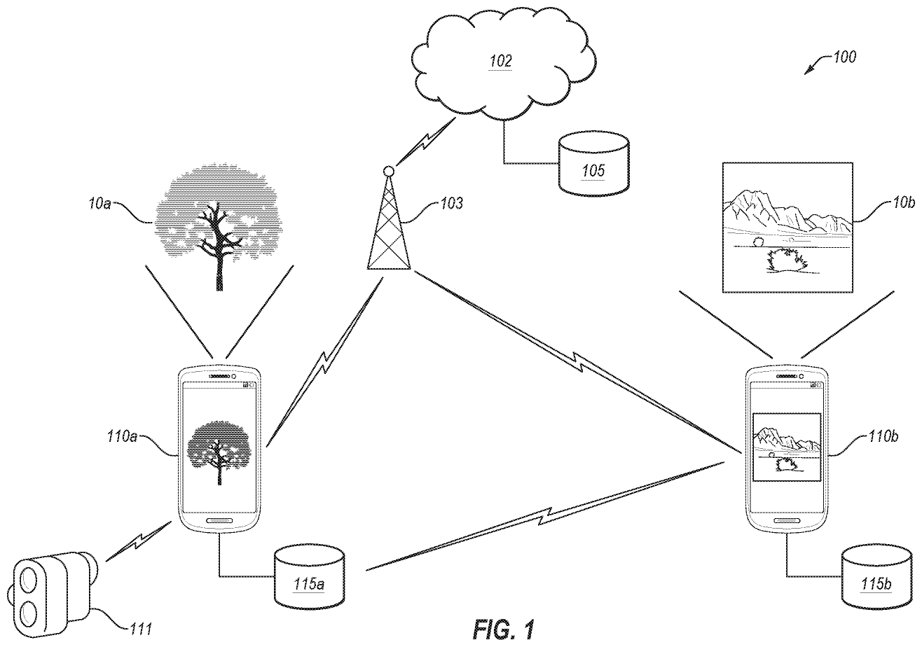

FIG. 1 depicts an example of a system 100 for map creation, referencing, and user interaction according to some embodiments. As shown in this figure, one or more client devices, such as client devices 110a and 110b, may be configured to communicate with one or more servers and/or databases over a network 102 via any suitable communications link or communication protocol 103 (preferably wireless protocol), such as radio, cellular, satellite communication links, Bluetooth®, WIFI, ultra-wide band (“UWB”), Zigbee®, and or any other suitable communication protocol(s) available to those of ordinary skill in the art.

The network 102 may comprise the Internet, a local area network, a virtual private network, and/or any other communication network utilizing one or more electronic communication technologies and/or standards (e.g., Ethernet or the like). In some embodiments, the network may comprise a wireless carrier system, such as a personal communications system (“PCS”), and/or any other suitable communication system incorporating any suitable communication standards and/or protocols.

Client device(s) 110a/110b may comprise any computing device suitable for implementing the inventive systems and/or methods and preferably comprising a processor, including but not limited to a smartphone, personal computer, a laptop computer, a desktop computer, a notebook or tablet, and the like.

Information pertaining to the system 100 may be presented to various clients/users in an application operating on the client devices 110. This application may comprise, for example, a general-purpose web browser application, a special-purpose application, such as a mobile phone application, or the like.

Various databases and/or datastore elements may also be provided in system 100 as needed. For example, in the embodiment depicted in FIG. 1, a server 105, which may include a database, may be accessible to multiple client devices 110 via network 102. Similarly, individual databases may be accessible only to each client device 110 but may under certain circumstances be made available in part (information from one database transferred to another, for example) to other client devices 110. For example, client device 110a may comprise a database 115a and client device 110b may comprise a database 115b.

Any of the various databases/data stores referred to herein may be configured to store electronic information in any suitable manner, which may include use of, for example, random access memory (“RAM”), non-volatile memory (“ROM”), and/or one or more bulk non-volatile non-transitory computer-readable storage mediums (e.g., a hard disk, flash memory, etc.) for storing programs and other data for use and execution by a processor or processing unit of a computing device.

One or more of the client devices 110 may have a companion client device, such as a rangefinder 111, as shown in FIG. 1, which companion device is preferred communicatively coupled with the client device (110a in the depicted system 100). In still more preferred embodiments, this communication may be wireless, again using any of the aforementioned communication protocols or any others available to those of ordinary skill in the art. Examples of other possible companion client devices include binoculars, monoculars, optical scopes, and the like.

As generally indicated in FIG. 1, system 100 may be configured to allow one or more users to create one or more map points using client device(s) 110 and allow for collaboration of information about such map point(s), improvement of the accuracy of the map point(s), creation of additional useful information about the map point(s), such as adding a variety of distance markers between various map points and/or items/markers on a map or real-time view including one or more of the map points, etc.

For example, the user associated with client device 110a may view an object of interest, such as a tree 10a using a smartphone or another client device 110a. Using data and/or processing that may be generated by a mobile application and/or server device, such as server 105, a point on a map may be correlated with the location of the tree. Examples of elements on the client device 110a that may be used to generate useful data for this purpose include, but are not limited to, cameras, accelerometers and/or gyroscopes for device orientation and movement, Global Navigation Satellite System (GNSS) or Global Positioning System (GPS) elements, compass/magnetometer, barometric sensors, and WIFI, cellular, Bluetooth, or other communication interfaces to exchange maps and/or map point information with other users or data repositories.

If the user associated with client device 110a wanted to share the location of the tree being viewed, the location of which may be further established by one or more of the additional sensors or other elements previously mentioned, with the user associated with client device 110b, the location of the tree may first be placed on a map. In some cases, the map may be part of a specific module that may be made available for download by a user upon traveling to a particular region. For example, before vacationing in Paris, a Paris module may be downloaded by one or more of the users of system 100, which may improve functionality and/or reduce or, in some cases, eliminate, the need for having an active connection to network 102 to achieve all aspects of the functionality provided by system 100.

The location of the tree or other item on this map may be precisely determined using one or more of the various features/elements of client device 110a and/or server 105 as desired. For example, in some embodiments, data derived from the GPS-identified location of the client device 110a may be combined with data from sensors on a smartphone or other client device 110b, to establish the orientation of the camera used to view the tree, which may allow for creation of a viewing vector with an accompanying viewing cone space. The location of the tree or other element being viewed may then be more precisely identified on the map using this data.

In some embodiments, data from a companion client device 110a, such as rangefinder 111, may be used to further enhance the accuracy of the location on the map. For example, rangefinder 111 or another suitable device, or in some embodiments a feature provided within client device 110a itself, may be used to identify a distance to the tree or other object. Using this distance data, along with the directional information associated with the original image/view, the location on the map may be very precisely determined. This location may then be highlighted on the map in any desired manner. For example, in some embodiments, the location may be identified using a star or other icon or marker.

If the user associated with client device 110b has downloaded or otherwise has access to the same map, the location of the tree or other item of interest may be sent from client device 110a to client device 110b (in some cases via server 105 and in other cases directly) to allow, for example, the user associated with client device 110b to find the same object from his or her location, which may differ from that of the user associated with client device 110a.

In some embodiments and implementations, data from the user associated with client device 110b may be used to improve the accuracy of the location of one or more elements, such as the aforementioned tree. For example, if the user associated with client device 110b uses his or her device to view an object of interest, which may be within a scene 10b, which scene may include the aforementioned tree from a different perspective, the location of the point on the shared map may be refined using data sets from both users. For example, GPS, compass, and/or inertial orientation data from both users, or in other implementations by a single user taking views of the same target at different distances and/or orientations, may be combined to provide a more accurate result. For example, it is anticipated that providing two averaged measurements may reduce error by approximately 20% and three averaged measurements by approximately 40%. Similarly, optical views combined from different directions may result in more accurate readings of a device's spatial mechanisms. The magnetometer's (compass) Hall Effect and the accelerometer and gyroscope measurements, for example, have improved accuracy resulting from approaching the target from different directions. Similarly, by using views spanning from one side of the field of view to the other, the result may be similar to using multiple observation targets and averaging the final result between them.

In some embodiments and implementations, each of the various users/client devices 110 may be configured to provide real-time map data communication, which may include updates to locations of items of interest and/or each user's current location. Similarly, in some embodiments and implementation, users may be allowed to send and/or receive real-time text and/or speech data, either to all users in a group or to a single individual user or grouping of users at their option. For example, hunters can communicate real-time through a central database server instead of using radio devices while using system 100.

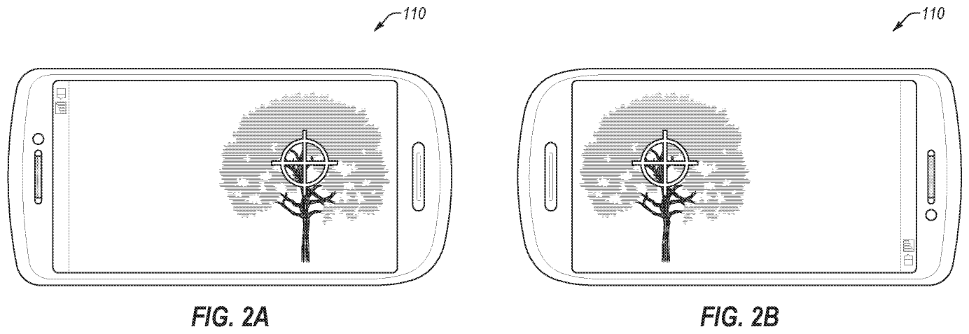

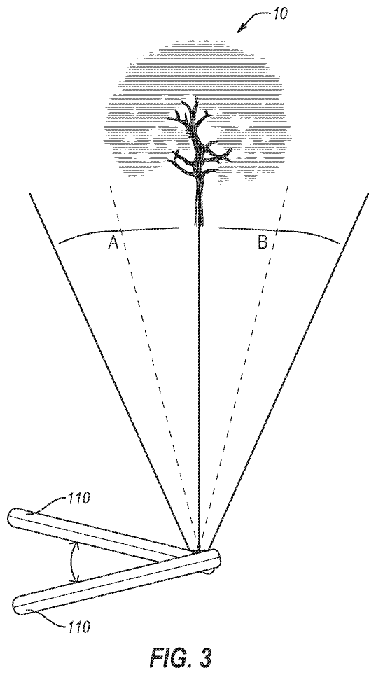

FIGS. 2A, 2B, and 3 illustrate the way either a single user, or two remotely connected users near an object of interest, may provide sets of information about the object from multiple different perspectives and/or distances to improve the accuracy of plotting the object on a map. FIG. 2A depicts the object (a tree) being imaged on a client device 110 (a smartphone) from a first perspective with the tree on the right side of the field of view of the client device and FIG. 2B depicts the object being imaged on the client device 110 from a second perspective with the tree on the left side of the field of view.

As indicated in FIG. 3, which shows the field of view of a device 110 camera resulting in the image of FIG. 2A along angle A and the field of view from device 110 resulting in the image of FIG. 2B along angle B, the two images may be taken in some implementations at the same location by simply rotating the device used to take the two images. In this manner, because the two images have different orientations and therefore different data sets (compass bearings, for example), the data sets may be combined to arrive at a more precise location for the object, which may then result in a more precise map point on a digital map that may be provided to one or more users.

In some embodiments and implementations, the object may be imaged from opposite sides of the viewing window/field of view, as shown in FIGS. 2A, 2B, and 3, which may make the processing simpler by allowing for averaging the two data sets. In other words, in some cases, the subject/target 10 may be identified as being located at the mid-point of the two views and/or accompanying data sets recorded. Similarly, in some embodiments and implementations, the user may be directed to image the target 10 from the two most distinct perspectives possible from a particular location, or may be directed to move to a new location if insufficient averaging data is obtainable from a single location. In embodiments and implementations in which a single location is used, the user may be guided to, either through a display/user interface or via an instruction manual, for example, to view the object with as much space/viewing window on one side of the target and then the opposite side, as indicated in FIGS. 2A, 2B, and 3.

In some such embodiments and/or implementations, more than two such views/data sets may be taken. For example, in some cases, a series of images and/or accompanying data sets may be recorded, preferably along a continuum from one perspective to the other. For example, with reference again to the implementation depicted in FIGS. 2A, 2B, and 3, instead of taking just the two images shown, a series of intermediate images, in some cases along with accompanying data sets, may be taken, preferably at regular intervals between the two extremes, to further enhance the data provided thereby.

In some embodiments and implementations, the client device and/or a companion device may be configured to automatically take each of the various images and/or data sets previously mentioned. For example, in some embodiments, the imaging device used may comprise a rotating and/or pivoting aperture/lens that may be configured to take an image of an object of interest, in some cases at one side of the field of view or the other or, alternatively, at the center of the field of view, and then may be configured to rotate the field of view automatically in one or both directions to take the other views and/or accompanying data.

In a more particular example, a user may image an object of interest. In some implementations, the user may first select a location, which may access a downloaded data module associated with the location, which may take place before the imaging step. The user may center the field of view on the object. In some cases, there may be a reticle, bullseye, or other visual element to allow the user to target a specific object in the field of view. The device may then record the phone orientation, compass data, and/or other data associated with the image and then automatically rotate the field of view of the camera to place the object at a left-most position in the field of view, after which the device may again record the phone orientation, compass data, and/or other data associated with the left-most perspective. The field of view of the camera may then rotate again to the right-most position and again record the associated data. In this manner, a user need only identify the point of interest in the field of view once and the device may do all the other work to ensure that sufficient data is taken to accurately represent the item of interest on a map. The device may optionally record data at additional various points along the way as needed to improve the accuracy further.

In various implementations, different methodologies may be used to determine the map point and/or relevant distances, in some cases along with terrain data to allow for positioning of the item of interest on a terrain map, if desired. For example, in some implementations, the remote map point may be determined at a specified distance—which may be determined by a companion rangefinder device in some embodiments—from the current position toward the subject point. Horizontal distance, line-of-sight distance, or both may be used during the calculations as desired. The vertical tilt of the client device/camera at each of the various perspectives may be used to calculate the horizontal map distance.

Alternatively, if a terrain intersection method is used, the remote map point may be determined as the intersection of a line from the current position of the user(s) toward the subject point and intersecting with a terrain elevation map.

In some embodiments and implementations, a GPS-aligned map and a terrain map representing elevation values at specific points across the GPS map may be combined during the analysis and/or display. For example, the optical view or views may be used to establish a map point by calculating the intersection of the view(s) with the terrain map. In some embodiments, the terrain elevation map may be a grayscale image of the map area with each pixel of the image, or each grouping of pixels, representing an elevation of an associated point on the map. Known interpolation and/or intersection mathematics may then be used to determine the intersecting point. It may be advantageous for some purposes to use a grayscale map due to the relatively small database storage required, which may improve the efficiency and/or speed with which the elevations may be determined and allow for easier sharing of map information through a central database.

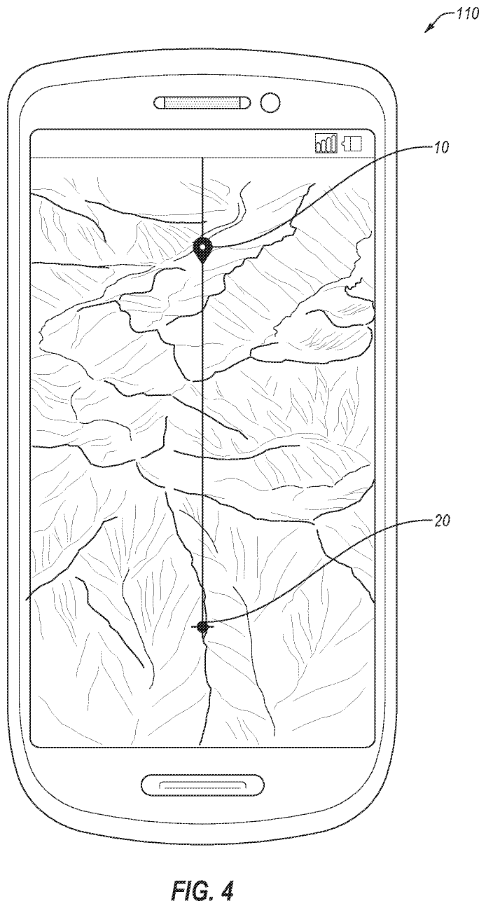

FIG. 4 depicts an example of a display on a client device 110 comprising a mobile smartphone comprising a map point 10, which may correspond to a target and/or object of interest, at a specified distance from the user's location 20 and/or at the intersection point with the terrain map. In some embodiments, as discussed below, an approximate distance to the object of interest and/or distances to other items in the map may also be displayed. The line shown on the display may be used to place the icon 10 by using the compass heading and/or other sensors on the device when an initial image of the target is taken, and may be shown extending between the target object and the user's current location, which may allow various other distances to other objects in the display to also be shown, as discussed throughout this disclosure.

Some embodiments and implementations may further comprise unique techniques for measurement of, and compensation for, errors in the data used to derive distances and/or map locations. Current compass magnetometers in mobile devices can have errors that negatively impact the placement of the derived map points. However, accelerometer/gyroscope (orientation) measurements in mobile devices typically have less error than compass magnetometers. Thus, using the technique previously described wherein the field of view rotates back and forth relative to an object of interest, both the compass bearings and orientation readings may be measured at each location and/or orientation. The difference between the orientation readings and the compass bearing represents compass error.

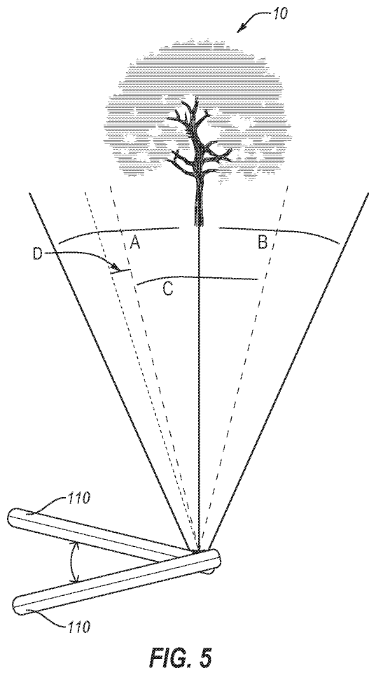

With reference to FIG. 5, an example of how this technique may be applied will be described. As previously mentioned, a single user, or multiple users, may view a target object, such as the target/tree 10 depicted in FIG. 5, from multiple perspectives and/or distances, in some cases from the same spot but different viewing angles, using a mobile device 110. When the target object is positioned at opposite ends of a viewing window, as previously described, then angle A will be equal to, or at least substantially equal to, angle B. Similarly, if the compass is accurate, then angles A and B should be qual to, or at least substantially equal to, angle C.

As the client/mobile device rotates with centerline of view from centerline B to centerline A, the compass bearings and the change in orientation of the device are measured. The difference in the measured angles represents the compass error angle D on an individual reading.

The average of the two compass bearing readings with error (AVB) may then be calculated as (RightBearing−LeftBearing)/2. Similarly, the compass bearing error compensation (CBC) may be calculated as (−A/2+(RightBearing−LeftBearing))/2. And the average compass bearing with error correction (AVBC) may then be arrived at by taking AVB−CBC, which may be used as the final compass bearing for purposes of the placement of the target on a map and/or distance measurements and markups. It is anticipated that this technique may reduce compass error on a single reading by about 80%.

In some embodiments and implementations, one or more map points may be displayed in a current optical view of the user's client device. In addition, in some embodiments and implementations, estimated distances may be displayed using lines, alphanumeric text, or other suitable markers between the user's current location and the map point and/or between various items and/or locations currently in the optical view.

To illustrate with a particular example, the user can activate the client device comprising a camera or other optical viewer and point it in the direction where map points refer to points in the local vicinity. For example, if a map point denotes the top of a nearby hill, when the nearby hill's map point comes into the user's view, the map point (on top of the hill) may be highlighted in the view in some manner, such as by way of a pin marker, bullseye, or the like. When the map point appears, the user can query distances on the screen and/or may be presented with distance information on the screen representing distances between the user and the map point, distances at various other lines or markers on the display, either relative to the map point or from the user.

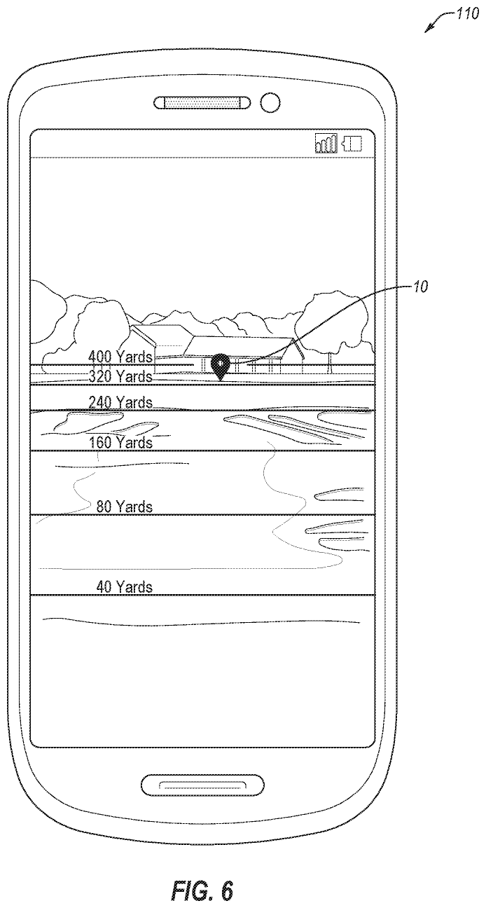

As an even more specific example with reference to FIG. 6, the system may be specifically configured for use by golfers. Thus, a golfer may identify a map point of interest as the flag or the center of the green for example. In some embodiments and implementations, this may be done by placing the location of this object of interest, as previously described within a viewer, either using a client device 110 or a companion device, such as a rangefinder. Alternatively, by downloading a prior data module that may be associated with a particular golf course, each of the flags and/or green centers of each hole may be preidentified.

Thus, when the golfer points his camera or other viewer at a green, he may see the desired map point in the view highlighted with a marker 10, as shown in FIG. 6. In some embodiments, distance lines may also be superimposed or otherwise displayed on the view in front of the map point and/or beyond it. These lines may allow the golfer to estimate the distance not just to the flag and/or center of the green, but also to surrounding objects in view, such as bunkers in the fairway.

In some embodiments and implementations, while the distance lines are being displayed, the system may be configured to allow the user to select other reference points being displayed on the screen and/or add additional reference points. For example, the user might select one of the bunkers to provide a more accurate reading of the distance to the bunker and/or the size of the bunker by estimates of the distances to one or more edges of the bunker, for example. These distances may be estimated using the calculated distance between the user's current position and the initial map point in proportion to the screen distance to other locations on the display using appropriate factors to account for the terrain.

For example, as shown in FIG. 6, a user may have identified the center of the green as an initial marker, and may have the distance to this location displayed, either automatically or by selecting the marker on the display. Then, the system may be configured to display a series of other distance markers, such as the lines shown on the display of FIG. 6, to allow a user to determine, at least in approximation, distances to other locations along the fairway towards the green. If a user wishes to obtain a more accurate reading of a distance to another target, such as one of the fairways, this may be obtained by using one of the methods previously described, such as by viewing the target from various perspectives for example, to improve upon the accuracy of the distance reading and/or placement of the target and its surroundings on a terrain map.

As another example, the system may allow hunters to employ a similar technique whereby a hunter may spot game at a particular time and use one or more of the methods and/or function disclosed herein to cause the game to be displayed on a map and/or cause distance markers to be displayed on the map to indicate how far the game is from the user and/or other prominent features on the map. In some cases, other hunters/users may be involved in the process of providing location and/or distance information such that a group of hunters in an area may each be involved in spotting game and placing the game and/or distance markers on a common map.

As yet another optional feature, in some embodiments, time markers and/or directional markers may also be placed on a map for use by a single user or a group of users contributing information to a common map. For example, if a game is spotted at a first location, a time marker may be linked with the first location and/or displayed on the map next to the location. If the game then moves to a second location, another time marker may be data stamped/associated with the second location and/or marked on the map. By using the time and location markers, a direction of the game may also be obtained and displayed on the map. For example, arrows may be used at each spotted location to indicate the direction of the game movement. In addition, or alternatively, lines may be drawn through each spotted location to provide an estimated path of the game.

In some embodiments and implementations, map databases with associated elevation data and map points can be shared between users, either directly, via sharing of local database information, or through a central cloud or other central database and/or network.

For example, a path of a user, or a group of users, which may include each user within a particular region or selected grouping, may be tracked on a map and their respective movements shown historically over a specific period of time on the map to show each user in the group not just the current position of other users but also their respective paths during a predefined time frame.

Target objects and/or locations may also be shared with other users, such as rendezvous points and/or locations of objects of interest along the way. For example, users of a system designed for hunters may share locations of game spotted or tagged. Similarly, the direction of travel of other moving objects, such as current movement of game, direction or travel, and/or historical paths during available times may be displayed for view by other users.

In some embodiments, predictions derived from data provided by users may be displayed. For example, predicted direction of travel of other users or other objects, such as game, and/or predicted times of arrival of users or other objects may be displayed based on historical data. Travel predictions may be derived from, for example, previous travel times and terrain and/or elevation data.

As yet another example, in some embodiments a planned journey path may be displayed, in some cases along with visibility indicators into adjacent valleys based on terrain slopes or other items of interest. The visibility indicators may be provided by, for example, using the user's current position on the map and comparing that location and elevation to one or more known surrounding points and/or associated elevations. An example of a method to represent and/or store elevation values is to use a grayscale image of the terrain, which may be provided by the user operating the application, another user in the system, or pre-stored on the phone or on a server of the system. The value of each pixel may then be correlated with and used to generally represent its elevation. Then, one method for representing the view into an adjacent valley or other feature currently out of sight to the user is to show the pixel points on the map with no visibility darker and the pixel points with visibility lighter. For example, the terrain in the bottom of the canyon may be dark because the vantage point view is hidden from the specified location or path. The terrain on the opposite hillside may be lighter because it would be visible from the point or path of interest. As another example, a hunter may plan a hiking path and the map may display how deep his view will be into adjacent valleys.

Some embodiments may also display sunrise and/or sunset shadow casting on terrain based on time and elevation. For example, in some embodiments, terrain shadows may be shown on mountains and valleys for a specified time of day, which may allow big game hunters to determine likely game locations near dusk. Methods for determining shadow casting positions may be similar to the methods described herein for determining vantage point visibility with associated elevation data, in some cases in combination with using the known location of the sun with respect to the user position and/or proposed path provided by the user. For other purposes, water identifiers may also be provided, in some cases with circular distance rings or other distance markers around them. For hunting applications, the distances may provide estimates of likely animal proximity to the water targets.

Some embodiments may also, or alternatively, allow for identification and/or classification of objects in the optical view and/or the ability to share such information with other users. For example, using the hunting use case, a user may be allowed to manually identify and classify animals and share the information with other users. Alternatively, animals may be identified using software, such as AI software, trained neural network software, or the like. These animals may then be tracked and have locations and/or paths displayed to other users, in some embodiments along with an indicator of the type of animal, such as an icon or other image of the animal.

As a more specific example, a hunter may observe terrain with an optical device, AI software using pre-trained neural networks may identify game in the view. Map points may then be created for each animal based on the viewing position of the optical device, the elevation terrain map data, and/or distance information provided from one or more users, such as from a rangefinder or other companion device. As the hunter observes the game within the field of view of the client device and/or companion device, a software module may identify other features of the game, such as the antler score of the animal. The neural network may be trained with known images of antlered animals and their respective known scores to provide for this feature. Knowing the map point location of the animal relative to the user's current location may also provide information that can be stored, shared, and/or displayed about the size of the animal and/or the antlers or other features of the animal relative to the distance, the optical field of view, and/or zoom factor. These estimates/data can also contribute to improve the accuracy and efficiency of the AI/neural network software. The animal map point locations, feature scores, and/or antler scores can be shared with other hunters through device-to-device communication, either directly or indirectly through a server or other centralized database and/or computing device.

As another example, a construction worker may view a location in the distance, which may correspond with a likely spot for a particular job or obstacle and wants to locate that point on a map. The worker points his phone or other viewer at the location and acquires multiple visual data points, either from the same distance at different perspectives or different distances, as previously described. The compass bearing error or errors may then be determined and a point may be created on an electronic map. In some cases, estimated error bars or other markers may be displayed to allow the worker to estimate the possible errors in the display and possibly seek additional data to improve upon the accuracy of the display.

Similarly, referring again to the hunting application, a hunter may shoot game at a distance. Often in mountainous areas, a hunter struggles to locate the game when he arrives at a perceived “game drop” location as the terrain looks different and is not recognizable. After the hunter shoots the game, he determines the distance from his current location to the “game drop” location using an available rangefinder device or range finding technique. Using his phone or other viewer (which may be the same rangefinder device in some applications) the hunter captures multiple views of the remote “game drop” location in the distance. Using terrain elevation data, range distance, local GPS position, compass heading, and/or device orientation, the “game drop” location may be identified and transferred to an electronic map using a suitable marker. The hunter can then compare his current location to the “game drop” location as he is searching for the bagged game. The hunter can also see the “game drop” map point on the camera view as he gets closer to that location and can be shown distances to the map point, similar to the distances provided in the golf application previously discussed.

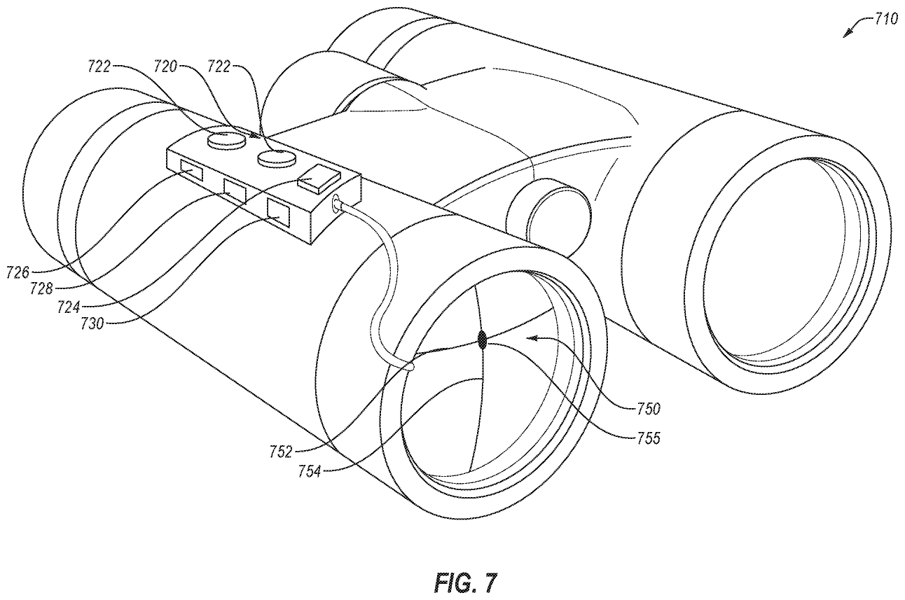

FIG. 7 depicts a pair of binoculars 710 that may be used to implement various other embodiments/implementations of the invention. Binoculars 710 may be modified with various hardware and/or software elements to function alone (at least from the perspective of the user) to implement the features/functions described below. Alternatively, binoculars 710 may, as described above, be used as a companion device with a communications link, such as a Bluetooth™ communications link or the like, with a mobile smartphone or another device with additional functional features and elements to supplement those of the binoculars 710. In addition, as those of ordinary skill in the art will appreciate, binoculars 710 are but one example of a device that may be used to implement the various functions/features described here and may therefore be replaced by any other suitable device with a viewfinder, lens, and/or camera, such as monoculars, range finders, and other optical scopes.

In the depicted embodiment, binoculars 710 may be configured similar to a typical set of binoculars and may therefore include various elements, such as eyepieces, lenses, focus adjustment wheels or other focus adjustment means, and the like. In addition, however, binoculars 710 may comprise one or more elements not typically present on a standard pair of binoculars, such as processors, sensors, electronic storage media, GPS receivers, Bluetooth™ transceivers, and graphical user interfaces.

In the depicted embodiment, many of these elements may be found within a smart module or patch 720, which is shown coupled to one of the viewing barrels of the binoculars 710 but may be coupled internally, or elsewhere, in other embodiments. Module 720 may comprise various buttons, switches, sliders, or other actuation elements 722. Actuation elements 722 may be used to provide input for certain smart features of the smart binoculars 710, such as selecting targets within a viewing window, adjusting the way certain elements, such as alphanumeric distance markers, show up in the viewing window, or activating/deactivating certain smart elements of binoculars 710.

In addition to buttons/actuation elements 722, smart module 720 may comprise, for example, one or more processors 724, a GPS receiver 726, a communication transceiver 728, such as a Bluetooth™ or other short-range or other transceiver/communication link, and/or one or more sensors 730, such as gyroscopes, accelerometers, compasses, and the like. In embodiments including a Bluetooth™ or other suitable communication link, one or more functions/features may be provided by a corresponding device, such as a mobile smart phone or other mobile device. However, in some embodiments, each of these features/functions/elements may be built directly into a device that may otherwise be used as a companion device, such as binoculars 710.

As discussed in greater detail below, a graphical user interface may be overlaid on the imagery viewed within the scope/viewing window of the device 710. Thus, as shown in FIG. 7, in some embodiments, a user may see a graphical user interface overlay 750 comprising a pair of axes, namely, a horizontal axis 752 and a vertical axis 754. Graphical user interface overlay 750 may be used, for example, to identify targets and/or to guide users to targets, such as targets previously identified by the user or targets identified by other users, such as other users of a downloadable app and/or other users in a global network. In the depicted embodiment, a target may be identified by an icon 755, such as, in the simplest example, a dot.

In some embodiments, rather than building this functionality into a device, such as binoculars 710, a user may retrofit a pair of binoculars or another suitable device having a viewfinder with this functionality. In other words, a device, such as module 720, which may contain all of the necessary sensors, electronics, etc. to perform the functions described herein, may be mounted to binoculars 710, which may have previously been a typical pair of binoculars without any electronics built therein. Module 720 may include one or more display units, which may be fitted to one or both of the binocular eyepieces and/or lenses to modify the view according to include one or more of these features/functions. As another example, in some embodiments, a smart phone or other mobile device having the capability of performing one or more such functions may be mounted to a pair of binoculars or another device with a viewfinder to modify the device accordingly.

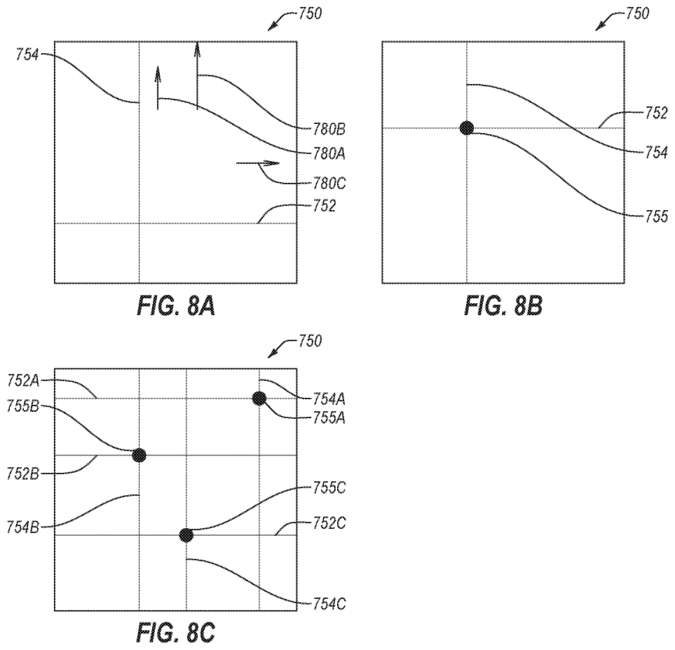

FIGS. 8A-8C depicts various views of a graphical user interface 750, which, again, may be built into a pair of binoculars or any other device having a viewfinder and/or camera. As shown in FIG. 8A, the graphical user interface may comprise various icons 780 that may be used to point a user in the direction of one or more targets, which may comprise, for example, targets previously identified by the user and/or targets identified by other users in the case of devices comprising long range communication links and/or mobile Internet access. In the depicted embodiment, icons 780 are arrows. However, various other icons may be used in alternative embodiments as desired.

In the depicted embodiment, there are three arrows, namely, arrows 780A, 780B, and 780C. A pair of axes including horizontal axis 752 and vertical axis 754 may also be used if desired to provide bearings from, for example, a common location and/or reference frame. Each of the arrows 780 may comprise a different length, which may provide an indication of how far from the current point of view in the viewfinder that particular object is. For example, arrow 780A is shorter than arrow 780B, which may indicate that a target associated with arrow 780A is “closer” (meaning less movement/rotation of the device/viewing window is needed to put the target into view) than the target associated with arrow 780B. Although only one horizontal arrow is shown (arrow 780C) in FIG. 8A, it should be understood that multiple such arrows may also be provided in some embodiments.

In some embodiments, a single target may have two arrows (one vertical and one horizontal) to guide a user to the target. Alternatively, a single visible arrow may be used to guide a user in a particular direction (i.e., either vertically or horizontally) once the user has put the viewfinder within a field of view that contains an axis (again, either vertical or horizontal) intersecting the field of view. In other words, arrow 780A, for example, may only become visible when the field of view includes a vertical axis that intersects both the target and the field of view. Prior to that, a horizontal arrow only may be visible. In some embodiments, as a user gets closer to viewing the target in the field of view of the viewfinder, the arrow may get progressively shorter, and vice versa. In addition, in some embodiments, diagonal arrows may be used to more precisely direct a user towards a previously-identified target.

Some embodiments may also be configured to use different types, styles, or colors of icon to indicate different targets. These differences may be adjustable according to user preference. For example, a red arrow may indicate a target that is most important to a user, such as a location of a game animal. Other colors may be used to indicate targets of a different type, priority, and/or user. For example, colors of icons, whether directing icons, such arrows 780, or icons of the targets themselves, such as dot 755 in FIG. 8B, may correspond with a particular user. A blue icon, for example, may be used to represent targets identified by a particular friend, and this color, or another suitable common identifier, may be used to identify both the target and the guiding icons if desired.

As shown in FIG. 8B, once a particular target 755 is in the field of view 750, arrows or other guiding icons 780 may be removed from the view. FIG. 8C depicts another field of view 750 of a graphical user interface containing three target icons, namely, icons 755A, 755B, and 755C. In this depiction, each of the icons has its own set of intersecting axes. In particular, icon 755A has associated axes 752A and 752B, icon 755B has associated axes 752B and 754B, and icon 755C has associated axes 752C and 754C, respectively. In some embodiments, these target-specific axes may be used, either alone or in conjunction with other guiding icons, to direct users to a specific target. In some embodiments, the aforementioned guiding icons, such as arrows, may be placed on the axes themselves to indicate that a particular target is located along one or both axes but not in the user's current field of view. The view in FIG. 8C may, for example, be the result of a user zooming the field of view outward to allow several objects/targets of interest to be visible, any one of which may be zoomed in upon to provide a more precise indication of its location. This view including each of the objects/targets of interest indicated by a respective target icon 755 may, in embodiments in which location sharing with other users is enabled, be visible to each such user within a particular group, or each user of the system globally if desired.

In connection with an app designed specifically for hunting, additional features may be provided. For example, when locating game on distant terrain, it is often difficult to relocate the game after having viewed it previously. Using binoculars or a spotting scope, a hunter will often see an animal at a specific location on a distant hill, for example, and then after looking away may lose track of the game. It is also very difficult to verbally convey to other hunters where the game is located and have them find it themselves in their visual device. To assist a hunter in repeatedly identifying game (or at least the last known location of game) and/or identifying game spotted by other hunters, a device, such as a mobile smartphone running a particular app, a modified device with a viewfinder, such as binoculars, or both, may be configured to allow a user to mark a particular location and easily come back to that viewing location. In embodiments and implementations in which users can share information, this location may also be shared with one or more other users via, for example, Bluetooth™ or another suitable communications protocol. Examples of user interfaces, algorithms, and other optional functions that may be provided with such an app or other software can be found in the drawings and throughout this disclosure.

In some embodiments and implementations, particularly for software directed to hunters, for example, the software may be configured to allow the user to reset or clear its memory of all previous locations and start tracking the spatial orientation of the device, which may be useful when a new hunt has been started to rid memory of game spotted during a previous hunt. If the user knows he will be sharing the information with other users, during or following this reset of previous tracking data, the user may view one or more key features in the display/field of view of the viewfinder, such as a prominent tree or rock. As the user sees game or other objects of interest (targets) in the scene, a software module/feature may be configured to allow the user to mark one or more such locations to allow future identification of the locations by the user and/or others in a particular group/network.

For example, the software may allow the user to add an icon and/or cross hairs, (see FIG. 7 and FIGS. 8A-8C), including but not limited to infinite crosshairs, on the location. As the user moves the view left, right, up, and down, the user may therefore see infinite horizontal and vertical lines drawn through the scene intersecting each location that has been marked, as shown in FIG. 8C. For example, the user might be scanning the scene and a horizontal line appears in the scene. The user then knows that line passes through a marked location somewhere. In some embodiments, as mentioned above, arrows or other guiding icons may be used in the scene to show the user which way to move (left or right) to get to the point of interest where an infinite vertical line crosses the horizontal line. In this manner, infinite cross hairs (horizontal and vertical lines) may be used as a guide to easily find locations of interest from the user and/or other users in the view. In some embodiments, these lines may be superimposed on the scene/field of view by software that tracks the spatial orientation of the device being used.

In embodiments and implementations involving collaborative sharing with others in a group, such as a group of hunters in a particular region, calibration of the device may take place initially. For example, a user may inform other users about a key feature or features, such as a prominent rock or tree, that was used as an initial reset or calibration point. This point may then be used, in some embodiments, as a “centerpoint” of the current hunting (or other collaborative activity involving maps/locations) session. Each user may then be prompted to reset or calibrate their tracking software while viewing that same feature. Then, one or more marked locations may be shared with each user in the group, which in some cases may be shared in the form of device orientation/sensor data to be interpreted by the software as a particular location on a map. In some embodiments, each device may display the aforementioned horizontal and vertical lines on one or more of the same scene locations as the primary user. If the center of the scene is used as the marked location, this method allows each user to be using any zoom level and still see the crosshair markers at the same location(s).

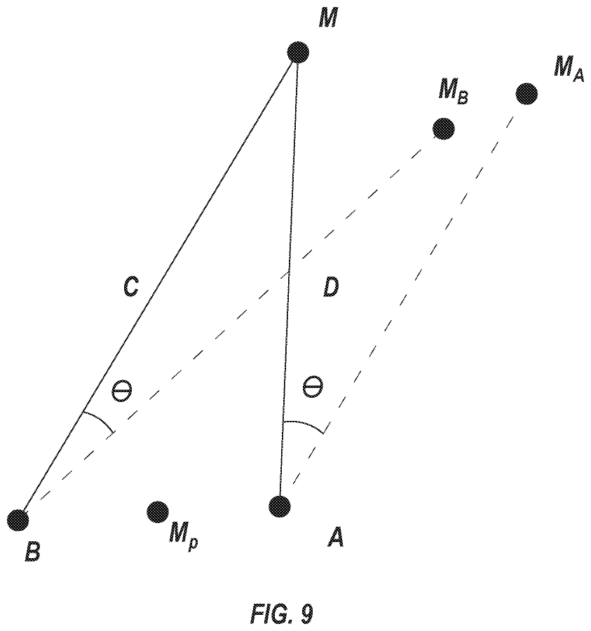

FIG. 9 is a schematic view illustrating the steps involved in improving the precision of remotely locating a distant object or other target on a map using a camera, mobile device, and/or other device having a viewfinder, such as the binoculars 710 depicted in FIG. 7. Although many such devices may comprise an electronic compass and other sensors, such as gyroscopes, accelerometers, and/or magnetometers, such sensors often introduce errors that may result in an undesirably inaccurate result. Such errors may be particularly important when assessing a precise location of a distant object or other target. However, by taking two or more photographs or other images of a distant target object or other target, preferably from two different locations, the error(s) introduced by the sensor(s) may be calculated and stored for future use. Thus, when only one photograph/image is taken of the same object/target in the future, using techniques disclosed herein, software on a mobile app or built into a device with a viewfinder, such as binoculars, can more accurately determine the actual location of the distant object/target.

To illustrate further with a specific example using the schematic diagram of FIG. 9, a user of a mobile smart phone or any of the other devices referenced herein that includes or otherwise provides access to suitable hardware, firmware, and/or software, a user at location A may point a camera or other viewfinder at a distinct object or other target at location M using the device, which may involve, for example, pointing the cross-hairs of a reticle overlaid on the display in the viewfinder to the target/object. In some implementations, a photograph may then be taken, which may trigger the device to record data from one or more sensors, such as from a compass and a gyroscope to provide orientation data, for example.

In other implementations, a photograph need not be taken. For example, a user may press a button to trigger recording of sensor data when a viewfinder is pointed at a particular target without requiring a photograph to be taken. As another example, the software may be configured to record sensor data when a user hovers a reticle or other icon at a desired target for a threshold amount of time. As these examples demonstrate, recording of data associated with a distant target may take place upon any of a variety of trigger events, which may be automated or manual.

In some implementations, the user and/or software may also take an approximate distance D to the target at location M. For example, if the user is using a rangefinder, an approximate distance may be manually obtained by the rangefinder itself and either automatically or manually recorded by the software/device. In other implementations, a known distance or a known estimate of the distance may be entered without use of a rangefinder or another similar device. As yet another example, in some implementations, if a user has previously located the target, such as on a map, but wants instead to locate his or her own position and place it on the map, a reverse methodology may be applied so as to determine location A and/or location B.

As mentioned above, in some embodiments and implementations, the rangefinder itself may include the necessary software, hardware, and/or firmware to accomplish these tasks. In other embodiments and implementations, the rangefinder may be used as a companion device, in some such cases a companion device that is communicatively coupled with another device having the needed software, hardware, and/or firmware. So long as the needed software, hardware, and/or firmware is present in one or more devices, this methodology may be viable, irrespective of the number of devices used. However, it may be desirable to provide all of the needed hardware/software/firmware in a single device in certain preferred embodiments.

Once an estimated distance is obtained, the user may then move away from location A, such as to location B, and may repeat the initial step by taking another photograph or otherwise recording sensor data with the viewfinder (preferably including a reticle or other means for targeting a specific object/location in the viewfinder) pointed at the same object/target at location M. In preferred embodiments and implementations, the software/device may be configured to prompt the user to move further away from point A in the event that point B is too close to point A to provide a suitable improvement to the error measurements. For example, a threshold distance may be calculated using the data collected at location A (the distance from A to M, for example) and the user may be prompted to move at least the threshold distance away, in some cases in a particular direction (such as at least approximately perpendicular to a line between A and M) before the user can take the second image or otherwise record the second set of sensor data.

In general, the further the target/location M is from the user, the further the user will need to move (between locations A and B) in order to provide a meaningful improvement to the error measurements. Thus, threshold distance is preferably linked to how far away the target/target object is. The further away the target/location M is from the user, the further the distance between A and B needs to be to get acceptable error calculation. The acceptable error may be adjustable by the user or pre-determined in the software. For example, in some embodiments and implementations, the distance between A and B must be at least 10% of distances C and/or D. Depending on the typical error in a specific hardware sensor, the acceptable error might be different for each device. For example, mobile phone sensors may have a typical error range that may improve over time as technology advances. Thus, an estimate of the error/error range may, in some embodiments, be a variable in the software.

In an alternative implementation of this error correction methodology, one or more other users may be involved. For example, instead of having the original user move to a new location, a second user may be involved in the process by viewing the target/object M from a different vantage point with respect to the first user. The object may be identified for the second user in a number of ways, including but not limited to being directed to the target/object by the app/software or by having the target/object described, either orally or in writing, to allow the second user to image the target/object from location B. In some such implementations, the second user may be prompted as to whether location B is sufficiently far from location A to provide a suitable error correction improvement.

As yet another example, in some implementations a first user may be able to locate one or more other users in the system. More particularly, let us assume, for example, that two users are out of sight with respect to each other but that both users can view of common object or other target from their respective positions. A first user of these two users may then take a first image of the common object/target and/or measurement of the distance to the common object/target and a second user may also take a second image of the common object/target and/or measurement of the distance from the second user to the common object/target. The software may then allow either user to find an approximate position of the other user and place the user on a map, in some cases along with the target/object.

After the user takes the second image and/or otherwise records the second set of sensor data at location B, the device/software may calculate error data to improve the assessment of the location of the object or other target at location M. In some embodiments and implementations, this may be done in the following manner, again, with reference to the diagram of FIG. 9. M_{A} in this diagram is the location of the target/object M as perceived from position A when error is introduced from one or more of the sensors used to obtain the aforementioned sensor data. Similarly, M_{B} is the location of the target/object M as perceived from position B when error is introduced from one or more of the sensors used to obtain the sensor data at location B. The angle Theta (θ) therefore represents the angular error of the device(s) used to estimate the position of the target/object M.

Although the two angles represented by Theta (θ) in FIG. 9 are not exactly the same, they can be assumed to be the same based on the minimal impact of their difference to the error calculation. The difference between C and D will determine how much error is introduced by assuming that the angles are the same. The relationship between the distance from A to B, the lengths of C and D, and the GPS locations of A and B may be used to determine if the angles can be assumed to be equal without adversely affecting the end result. This may be built into a software module to guide the user in determining if location B is an acceptable measurement point or if the user needs to move further from location A to provide meaningful error improvement.

In some implementations, the error correction methodology may proceed as follows. When the error angle Theta (θ) is zero, both lines AM and BM pass through the actual object/target location M. Thus, as error angle Theta (θ) gets larger, the distance between M_{B} and M_{A} gets larger until it reaches an approximate maximum equal to the distance between points A and B (AB). This maximum occurs when error angle Theta (θ) reaches 90 degrees. The error angle Theta (θ) can therefore be approximated by the ratio of the distances between A and B compared to M_{A} and M_{B} according to the following equation:

(A−B)/(M_{A}−M_{B})=θ/90 degrees

where

θ=(90*(A−B))/(M_{A}−M_{B})

If M_{P} is a midpoint between point A and point B, then the error angle Theta (θ) is negative (clockwise) if the distance from M_{A} to M_{P} is greater than the distance from M_{B} to M_{P}. Similarly, the error angle Theta (θ) is positive (counterclockwise) if the distance from M_{A} to M_{P} is less than the distance from M_{B} to M_{P}.

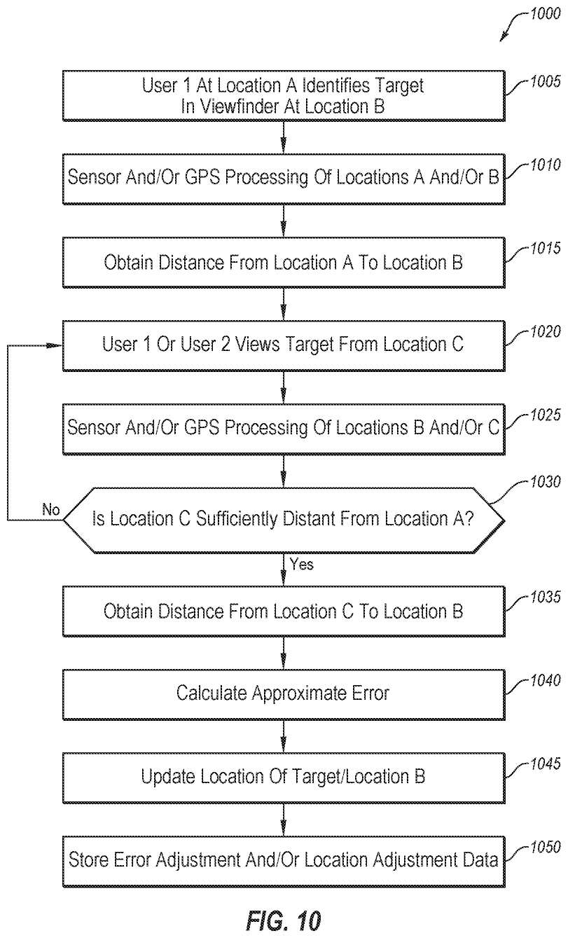

FIG. 10 is a flow chart illustrating various steps that may be used during certain implementations of inventive methods. It should be understood that none of the steps shown in FIG. 10 is required, nor is the specific order of steps necessary. Instead, the steps of method 1000 may be deleted, modified, or combined with other steps described in connection with other embodiments and/or implementations of the invention described herein.

Method 1000 begins at step 1005, at which point a user at location A may identify a particular object, feature, or other target at location B within a viewfinder of a device, such as a mobile smartphone, a tablet device, a pair of binoculars, which may either have suitable sensors and electronics built in or may be communicatively coupled with another device, such as a smartphone, having such capabilities. In some implementations, step 1005 may comprise, for example, viewing the target and taking a photograph of the target. In some cases, a reticle or other icon may be used to identify a target more specifically within a scene viewed within the viewfinder. In other words, for example, either the target may be moved onto a stationary icon, such as the center of a pair of cross-hairs, by moving the viewing window, or the icon itself may be moved by the user within the display onto the target, after which the photograph may be taken and/or the icon may be locked into place by the user, for example, pressing a button or using another suitable actuation element on the device.

Method 1000 may then proceed to step 1010, at which point various sensors or other elements of the device usable to identify or estimate locations A and/or B. For example, in the case of a smartphone, the software may, upon identification of a target, automatically record the GPS location of the user at location A and may record information from various sensors on the smartphone, such as a gyroscope, compass/magnetometer, etc., to establish the orientation of the camera/viewfinder used to view the target at location B. As mentioned above, in some implementations, this may allow for creation of a viewing vector to estimate location B to ultimately place the target on a map. This data may be recorded and linked with the target location for future use. It should be understood that any number of other targets may be identified by the first user (User 1) or any number of other users as desired.

At step 1015, a distance or estimated distance from Location A to Location B may be obtained. This distance may be obtained in a number of different possible ways. For example, in some implementations, the user may use a rangefinder device to obtain a distance estimate and then enter the estimate in the device having the viewfinder used to identify the target. This may be done, for example, using a keyboard or any other suitable input means. Alternatively, the device having the viewfinder used to identify the target itself may be used to obtain the distance estimate, either automatically or manually. For example, the device used to identify the target may itself be, or have, a rangefinder, which may allow the user to either obtain a distance estimate and enter it manually, or the device may automatically record a distance estimate during the process of identifying the target in step 1010. The distance measurement/estimate may then be recorded and linked with the identified target.

At step 1020, the user who identified the target may move to a second location (Location C) and view the target again from this location, preferably using the same technique (using an icon/cross-hair, for example) as during the identification of the target originally. Alternatively, a second user (User 2) may be notified of the target, either by User 1 or by the software/app, and then may use the same or a similar technique to view/identify the target at a different location than User 1 (Location C). By viewing the target from two sufficiently distinct perspectives, data from the two different perspectives may be used to reduce the inherent error in the sensors/elements used to estimate the location of the target and thereby improve the accuracy of the target location identification.

Similar to step 1010, data from the GPS receiver, sensors, and/or other elements of one or more devices used to view the target at Location C may then be recorded at step 1025. In some implementations, GPS data may be stored for Location C, along with data used to assess the orientation of the viewing of the target from Location C, which may be the same data obtained/stored in step 1010.

In some implementations, a query may be made, following step 1020 or step 1025, for example, to determine whether Location C is too close to Location A, at step 1030. In other words, a determination may be made as to whether, if User 1 took both views, this user moved sufficiently far in between views/data captures. In some implementations, the software may prompt the user to keep moving away from Location A in the event that a threshold distance has not been reached. The threshold distance may, in some embodiments, be pre-programmed. However, the acceptable distance between Locations A and C to provide meaningful improvement to the accuracy of the assessed location of Location B will increase as the distance to Location B increases. Thus, in some implementations, the software may calculate a threshold distance based upon the distance obtained in step 1015 and use this distance to calculate a distance threshold for the requisite distance between Locations A and C. As those of ordinary skill in the art will appreciate, algorithms for calculating this distance threshold may be implemented that assume, for example, that the threshold distance is equal to a percentage of the distance between Locations A and B. An appropriate percentage can be based on, for example, empirical testing or by back calculating the distance needed to produce an acceptable error at a reasonable distance from Location A to Location C.

In the event that Location C is too close to Location A, method 1000 may revert to a previous step, such as step 1020, at which point the user may move to another location (Location D—not specifically referenced in the diagram), and proceed with the identification and data collection steps previously mentioned. If, on the other hand, Location C is sufficiently distant from Location A, then a distance from Location C (or D if the initial second location was too close) to Location B (the target location) may be obtained, again, using any of the distance measurement/estimation techniques referenced above or otherwise available to those of ordinary skill in the art.

Once all the data has been obtained and stored, error calculations may take place at step 1040. Examples of algorithms for estimating compass and/or sensor errors can be found throughout this disclosure, including, for example, in FIG. 9 and the written description accompanying this figure.

Once the error adjustment calculations have been made, an update may be made to the estimated location of the target at step 1045. This may result in an improvement on the positioning of the target on a map viewable by User 1 and any other users in a group and/or network. In some implementations, the position of the target on the map will not be displayed until after the error correction/adjustment steps. The error correction adjustments may then be stored for future use at step 1050. This data may be used, for example, to improve target location identifications not only for the target used to obtain the data, but other targets, such as other targets at similar distances from users. In this manner, the system may improve over time or “learn” and may therefore be akin to artificial intelligence systems. This learning aspect of the system may apply globally to the system as a whole or may apply regionally to preserve storage space and/or processing power. In other words, in some embodiments, learning may take place within a particular hunting trip in a certain region for a subset of users of a wider group of users if desired.

As used herein, a software module or component may include any type of computer instruction or computer executable code located within a memory device and/or m-readable storage medium. A software module may, for instance, comprise one or more physical or logical blocks of computer instructions, which may be organized as a routine, program, object, component, data structure, etc., that perform one or more tasks or implements particular abstract data types.

In certain embodiments, a particular software module may comprise disparate instructions stored in different locations of a memory device, which together implement the described functionality of the module. Indeed, a module may comprise a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

Furthermore, embodiments and implementations of the inventions disclosed herein may include various steps, which may be embodied in machine-executable instructions to be executed by a general-purpose or special-purpose computer (or another electronic device). Alternatively, the steps may be performed by hardware components that include specific logic for performing the steps, or by a combination of hardware, software, and/or firmware.

Embodiments and/or implementations may also be provided as a computer program product including a machine-readable storage medium having stored instructions thereon that may be used to program a computer (or other electronic device) to perform processes described herein. The machine-readable storage medium may include, but is not limited to: hard drives, floppy diskettes, optical disks, CD-ROMs, DVD-ROMs, ROMs, RAMs, EPROMs, EEPROMs, magnetic or optical cards, solid-state memory devices, or other types of medium/machine-readable medium suitable for storing electronic instructions. Memory and/or datastores may also be provided, which may comprise, in some cases, non-transitory machine-readable storage media containing executable program instructions configured for execution by a processor, controller/control unit, or the like, of a computer or other computing device, such as a mobile smartphone.

The foregoing specification has been described with reference to various embodiments and implementations. However, one of ordinary skill in the art will appreciate that various modifications and changes can be made without departing from the scope of the present disclosure. For example, various operational steps, as well as components for carrying out operational steps, may be implemented in various ways depending upon the particular application or in consideration of any number of cost functions associated with the operation of the system. Accordingly, any one or more of the steps may be deleted, modified, or combined with other steps. Further, this disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced, are not to be construed as a critical, a required, or an essential feature or element. The scope of the present invention should, therefore, be determined only by the following claims.

1. A method for identifying and visualizing points on a map, the method comprising the steps of:
identifying a target with a viewfinder;
correlating the target with a location on a map using a GPS signal received on a mobile device operated by a user and one or more sensors of the mobile device;
displaying a visual representation of the target on the map in an app running on the mobile device; and
transmitting location data relating to the target to allow a second user operating an app on a second mobile device to identify the target on a second mobile device operated by a second user.

2. The method of claim 1, wherein the viewfinder is part of the mobile device.

3. The method of claim 1, wherein the viewfinder is part of a companion device communicatively coupled with the mobile device.

4. The method of claim 3, wherein the companion device is selected from the group consisting of binoculars, monoculars, rangefinders, and optical scopes.

5. The method of claim 1, wherein the one or more sensors of the mobile device comprise at least one of a compass, a gyroscope, and an accelerometer.

6. The method of claim 1, further comprising receiving location data generated from the second user.

7. The method of claim 6, wherein the location data generated from the second user allows a location of the target to be identified on the map with greater precision.

8. The method of claim 1, wherein the map comprises relative distance markers between two or more targets on the map.

9. A method for collaboratively identifying targets on a map, the method comprising the steps of:
identifying a target within a viewfinder of at least one of binoculars, a monocular, a rangefinder, and an optical scope operated by a user;
correlating the target with a location on a map;
displaying a visual representation of the target on the map; and
transmitting location data relating to the target to allow a second user to identify the target on a second map displayed to the second user.

10. The method of claim 9, further comprising receiving location data relating to a second target, wherein the location data related to the second target is generated from a device operated by the second user.

11. The method of claim 10, further comprising displaying one or more visual cues to assist the user in identifying a location of the second target on the map.

12. The method of claim 11, wherein the one or more visual cues comprises horizontal and vertical lines intersecting the second target.

13. The method of claim 12, further comprising displaying a prompt on at least one of the horizontal and vertical lines to direct the user towards the second target.

14. The method of claim 9, wherein the map is displayed within the viewfinder.

15. The method of claim 9, wherein the map is displayed on a screen of a mobile device communicatively coupled with the at least one of binoculars, a monocular, a rangefinder, and an optical scope operated by the user.

16. The method of claim 9, further comprising downloading a location-specific data module comprising data relating to geographical features of a specific location.

17. The method of claim 16, wherein the location-specific module is used to correlate targets identified with the viewfinder with locations on the map, and wherein the location-specific module allows for correlation of targets identified with the viewfinder without use of an Internet network connection.

18. A non-transitory computer-readable storage media having computer-executable instructions that, when executed by at least one processor, cause the at least one processor to perform a method, the method comprising the steps of:
correlating a target identified within a viewfinder with a location on a map using data generated from GPS signal received on a mobile device operated by a user and one or more sensors of the mobile device;
displaying a visual representation of the target on the map;
receiving location data relating to the target from a second user; and
improving the accuracy of the visual representation of the target on the map using the location data from the second user.

19. The computer-readable storage media of claim 18, further comprising:
estimating distances between two or more secondary targets, or between a secondary target and the target, on the map; and
displaying one or more distance markers on the map, the one or more distance markers being representative of estimated distances between two targets on the map.

20. The computer-readable storage media of claim 18, further comprising:
displaying visual cues to assist the user in identifying a second target identified by another user.
